(19) United States
(12) Patent Application Publication
(10) Pub. No.: US 2018/0144699 A1
(43) Pub. Date: May 24, 2018

(54) Driving Method of Display Panel and Display Device Comprising Such Display Panel

(71) Applicant: Shenzhen China Star Optoelectronics Technology Co., Ltd., Shenzhen, Guangdong (CN)

(72) Inventor: Dekang ZENG, Shenzhen, Guangdong (CN)

(73) Assignee: Shenzhen China Star Optoelectronics Technology Co., Ltd., Shenzhen, Guangdong (CN)

(21) Appl. No.: 15/125,158

(22) PCT Filed: Jul. 12, 2016
(86) PCT No.: PCT/CN2016/089746

§ 371 Date: Sep. 10, 2016

(30) Foreign Application Priority Data
May 4, 2016 (CN) 201610288295.6

(51) Int. Cl. G09G 3/36; G02F 1/1362

(52) U.S. Cl. CPC G09G 3/3648; G09G 2310/0264; G09G 2320/0233; G02F 1/136286

(57) ABSTRACT

The present disclosure discloses a driving method of a panel and a display device. According to the technical provided by the present disclosure, for the same source line, based on whether if between the data voltage provided by the current driving cycle and the data voltage provided by the previous driving cycle occurs the polarity change to compensate the data voltage provided by the current driving cycle based on the data voltage provided by the current driving cycle and the data voltage provided by the previous driving cycle. Because thee adaptive compensation of the data voltage of which the polarity is reversed, thereby providing the compensated data voltage to the corresponded pixel, so that the issue of the dim screen caused by the polarity inversion can be solved, thereby improving the display quality of the display panel.

### BACKGROUND OF THE DISCLOSURE

### 1. Field of the Disclosure

The present disclosure relates to a display technical field, and in particular to a driving method of a display panel and a display device comprising such liquid crystal display panel.

### 2. The Related Arts

Display panel, in particular to the liquid crystal display panel based on TFT-LCD is more commonly used in electronic device. Along with TFT-LCD technology matures, the cost competitiveness of TFT-LCD is increasingly higher, namely, the TV market applied TFT-LCD has been found the liquid crystal display panel with the Dual-gate/Tri-gate structure, which can reduce the amount of channels of the source integrated circuit, thereby reducing the costs. However, the inherent disadvantage of such Dual-gate/Tri-gate structure is: greatly reducing the charging time of the TFT-LCD, and the increase of the charging time is more obvious along with the clarity of the liquid crystal display panel.

In the Dual-gate structure, in order to avoid flicker too severe and typically using two line inversion driving mode, however, when the polarity of the data voltage provided by the source line is changed, the change value of the pixel voltage is larger, when the RC delay (the delay phenomenon of the voltage change caused by the resistor and capacitor charging for the voltage change) of internal cell is serious, the part of the sub-pixel will be charged insufficiently thus resulting the darkness of screen.

In order to solve the dim brightness as above description, generally adopting copper material for wire on array, WOA, traces and/or widening the WOA traces to reduce the cell impedance, reducing the extent of delay RC, increasing the charging efficiency. However, adopting cooper material for WOA traces needs TFT-LCD manufacturing process, and the transformation of such manufacturing process and the issues relating to the manufacturing process will generate significant costs, resulting the higher product cost, if widening the WOA traces, the area of the display region of the panel will be decreased, reducing the aperture ratio, the brightness of the backlight needs to be increased to improve the brightness of the backlight, the product cost still becomes higher.

### SUMMARY OF THE DISCLOSURE

In order to overcome the deficiencies of the prior art, the exemplary embodiments of the present disclosure provide a driving method and a display device of a display panel which can effectively improve the darkness of the screen.

The exemplary embodiment of the present disclosure provides a driving method of a display panel. Said display panel comprising a plurality of source lines arranged in first direction, a plurality of gate lines arranged in second direction which is perpendicular to the first direction and crossed said plurality of source lines, and a plurality of pixels which is provided on the intersection of said plurality source lines and said plurality of gate lines to form a two-dimensional array, said display panel being driven in progressive driving mode, comprising the following steps: for each source line of said plurality of source lines, to determine whether between a data voltage provided by the current driving cycle and a data voltage provided by the previous driving cycle has polarity change; when the polarity change occurs, when the polarity of the data voltage provided by the jth source lines is changed, to determine a compensation value based on the data voltage provided by the current driving cycle and the data voltage provided by the previous driving cycle; to compensate the data voltage provided by the current driving cycle based on the determined compensation values, to determine a final data voltage provided by the previous driving cycle.

Preferably, the steps of determining the compensation values comprise: only when the polarity change occurs, to determine the compensation values.

Preferably, the steps of determining the compensation values comprise: to calculate the compensation values based on the data voltage provided by the current driving cycle and the data voltage provided by the previous driving cycle; or to retrieve the compensation values from the look-up table based on the data voltage provided by the current driving cycle and the data voltage provided by the previous driving cycle.

Preferably, the data voltage provided by the source line is corresponded to the gray level value.

Preferably, said display panel is driven in column inversion driving mode, two column inversion driving mode, one dot inversion driving mode.

Another embodiment of the present disclosure provides a display device. Said display device may comprises a display panel, a plurality of source lines arranged in first direction, a plurality of gate lines arranged in second direction which is perpendicular to the first direction and crossed said plurality of source lines, and a plurality of pixels which is provided on the intersection of said plurality source lines and said plurality of gate lines to form a two-dimensional array. Said display device also comprises: a source driver, which is constituted to provide a data voltage to pixels through said m source lines; a gate driver, which is constituted to sequentially provide a driving signal to said plurality of gate lines in order to control the pixel to receive the timing of the data voltage; a controller, which is constituted to control the source driver to provide a data voltage, and the gate driver providing the sequence of the driving signals, wherein said controller is constituted to: for each source line of said plurality of source lines, to determine whether between a data voltage provided by the current driving cycle and a data voltage provided by the previous driving cycle has polarity change; when the polarity change occurs, when the polarity of the data voltage provided by the jth source lines is changed, to determine a compensation value based on the data voltage provided by the current driving cycle and the data voltage provided by the previous driving cycle; to compensate the data voltage provided by the current driving cycle based on the determined compensation values, to determine a final data voltage provided by the previous driving cycle.

Preferably, said controller determines the compensation values only when the polarity change occurs.

Preferably, said controller calculates the compensation values based on the data voltage provided by the current driving cycle and the data voltage provided by the previous driving cycle, or retrieves the compensation values from the look-up table based on the data voltage provided by the current driving cycle and the data voltage provided by the previous driving cycle.

As described above, for the same source lines, based on whether if between the data voltage provided by the current driving cycle and the data voltage provided by the previous driving cycle occurs the polarity change to compensate the data voltage provided by the current driving cycle based on the data voltage provided by the current driving cycle and the data voltage provided by the previous driving cycle, thereby providing the compensated data voltage to the corresponded pixel, so that the issue of the dim screen caused by the polarity inversion can be solved, thereby improving the display quality of the display panel.

The following description will partially elaborate the other aspects and/or advantages of the present disclosure, and a portion will be apparent through the description, or may be known through the embodiments of the present disclosure.

### BRIEF DESCRIPTION OF THE DRAWINGS

Describing the embodiments through combining the following drawings, the above description and/or the other purpose and the advantages of the present disclosure will be clearer, wherein:

FIG. 1 is a block diagram of a display device according to the exemplary embodiment of the present disclosure;

FIG. 2 is a schematic diagram of a part of the display panel as shown in FIG. 1;

FIG. 3A and FIG. 3B are respectively comparative diagrams of the driving method of the prior art and the driving method of the exemplary embodiment of the present disclosure;

FIG. 4 is a flow chart of the driving method of the display panel according to the exemplary embodiment of the present disclosure.

### DETAILED DESCRIPTION OF THE PREFERRED EMBODIMENTS

The exemplary embodiments of the present disclosure will now be described in detail, the examples of said embodiments are shown in the drawings, wherein the same reference numerals indicate the same portions. The followings will describe said embodiments through referring the drawings in order to explain the present disclosure.

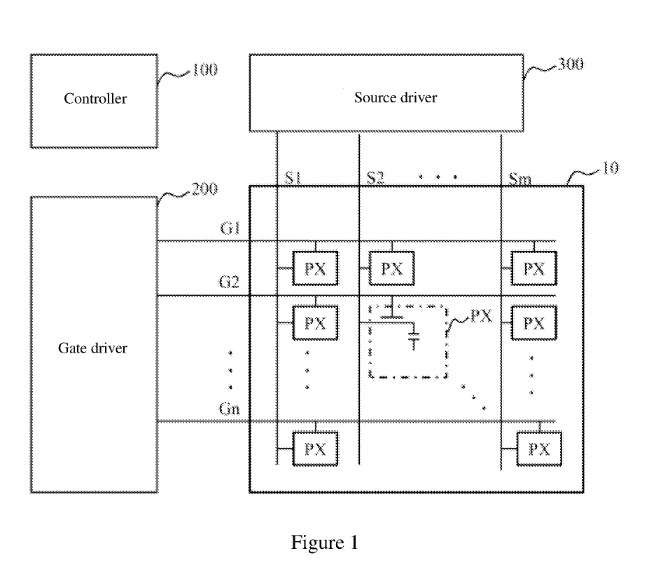

FIG. 1 is a block diagram of a display device 1000 according to the exemplary embodiment of the present disclosure. Refer to FIG. 1, the display device 1000 generally comprises a display panel 10 and a driving circuit of the display panel.

The display panel 10 comprises a plurality of pixels arranged in matrix and the display panel 10 is provided as a frame to display images. The display panel 10 can be a liquid crystal display panel, a light emitting diode, LED, display panel, an organic LED, OLED, display panel, an active matrix OLED, AMOLED, display panel, but is not limited here. In order to facilitate description, the following will take the liquid crystal display panel as exemplary of the display panel 10 and describe in detail.

As shown in FIG. 1, assuming that the display panel 10 comprises the gate lines G1 to Gn arranged in the row direction, the source lines S1 to Sm arranged in the column direction, and each pixel PX formed on the intersection of the gate lines G1 to Gn and the source lines S1 to Sm. Herein, each pixel PX may comprise a thin film transistor, TFT, and a corresponded capacitor which is connected to the drain of TFT.

Meanwhile, as shown in FIG. 1, the display panel driving circuit comprised by the display device 1000 may comprise a controller 100, a gate driver 200 and a source driver 300.

The controller 100 can externally (for example, the host device) receive an image data DATA1 and a control signal CONT, generating the control signals CONT1 and CONT2 used to control the gate driver 200 and the source driver 300 based on the received image data DATA1 and control signal CONT. The timing controller 100 also can be used to transfer the format of the image data DATA1 provided externally in order to conform the specification of the associated interface of the source driver 300. Therefore, the transferred image data DATA2 can be transmitted from the controller 100 to the source driver 300.

In response to the first control signal CONT1 and the second control signal CON2 provided by the controller 100 and the image pixel DATA1, the gate driver 200 and the source driver 300 simultaneously drive the pixel PX of the display panel 10. Herein, the first control signal CONT1 and the second control signal CONT2 can be one or more control signals, control packages and/or reference signals (for example, a clock signal, a voltage reference, reference data).

Refer to FIG. 1, the gate driver 200 determines which gate line in said n gate lines based on the received second control signal CONT2, namely, the gate driver 200 determines to send the driving signal (namely is gate turn-on signal) to which gate line if said n gate lines. The gate driver 200 can send the driving signal (namely is gate turn-on signal) to the corresponded gate line in the n gate lines, thereby the pixel PX connected with said corresponded gate line is activated to receive the data voltage provided through the m source lines (for example, a gray voltage corresponding to gray level value). Sequentially providing the driving signal (namely is gate turn-on signal) to said n gate lines to sequentially drive said n gate lines, namely, driving said n gate lines by using progressive driving method. In the following description, for ease of description, providing the driving signal (namely is gate turn-on signal) to the i gate lines to activate the pixel PX connected with the i gate lines in order to receive the time period of the data signal provided by the m source lines, which called ith driving cycle (or the ith driving cycle of the driving signal provided by ith gate line).

The source driver 300 outputs the data voltage connected to each pixel PX of activated gate line. Herein, the data voltage outputted to the pixel PX is corresponded to the gray voltage (or gray level value). Therefore, the display panel 100 can display the images in a line or row direction.

The source driver 300 is responded to the first control signal CONT1 and drives the source lines S1 to Sm of the display panel 10. The source driver 300 generates a data voltage (or gray voltage) corresponded to the image data DATA2 and outputs the gray voltage to the corresponded pixel PX through the source lines S1 to Sm of the display panel 10.

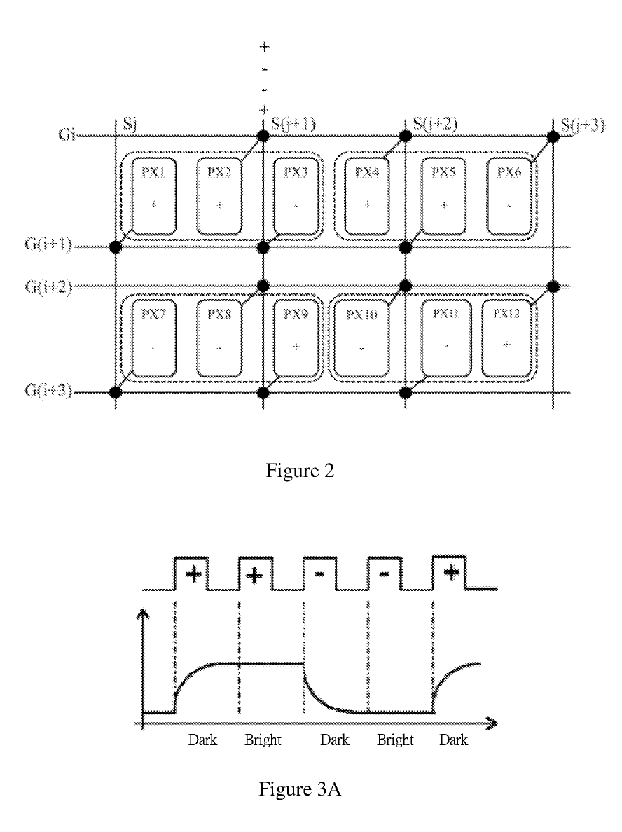

The following description refers to FIG. 2 to describe the driving method of the display panel according to the exemplary embodiments of the present disclosure. FIG. 2 is a schematic diagram of a part of the display panel as shown in FIG. 1.

In the embodiment as shown in FIG. 2, the pixel PX1 is connected with the intersection of the (i+1)th gate line G(i+1) and the jth source line Sj, the pixel PX2 is connected with the intersection of the ith gate line Gi and the (j+1)th source line S(j+1), the pixel PX3 is connected with the intersection of the (i+1)th gate line G(i+1) and the (j+1)th source line S(j+1), the pixel PX4 is connected with the intersection of the ith gate line Gi and the (j+2)th source line S(j+2), the pixel PX5 is connected with the intersection of the (i+1)th gate line G(i+1) and the (j+2)th source line S(j+2), the pixel PX6 is connected with the intersection of the ith gate line Gi and the (j+3)th source line S(j+3).

Meanwhile, the pixel PX7 is connected with the intersection of the (i+3)th gate line G(i+3) and the jth source line Sj, the pixel PX8 is connected with the (i+2)th gate line G(i+2) and the (j+1)th source line S(j+1), the pixel PX9 is connected with the intersection of the (i+3)th gate line G(i+2) and the (j+1)th source line S(j+1), the pixel PX10 is connected with the intersection of the (i+2)th gate line G(i+2) and the (j+2)th source line S(j+2), the pixel PX11 is connected with the intersection of the (i+3)th gate line G(i+3) and the (j+2)th source line S(j+2), the pixel PX12 is connected with the intersection of the (i+2)th gate line G(i+2) and the (j+3)th source line S(j+3).

In the embodiment as shown in FIG. 2, the pixels PX1, PX2 and PX3 are respectively a red sub-pixel, a green sub-pixel and a blue sub-pixel of a first pixel, the pixels PX4, PX5 and PX6 are respectively a red sub-pixel, a green sub-pixel and a blue sub-pixel of a second pixel, the pixels PX7, PX8 and PX9 are respectively a red sub-pixel, a green sub-pixel and a blue sub-pixel of a third pixel, the pixels PX10, PX11 and PX612 are respectively a red sub-pixel, a green sub-pixel and a blue sub-pixel of a fourth pixel.

When providing the gate turn-on signal through the ith gate line Gi, namely, in the ith driving cycle of providing driving signal through the ith gate line Gi, since the pixel PX2, pixel PX4 and pixel PX6 are connected with the ith gate line Gi, the pixels PX2, PX4 and PX6 are respectively received the corresponded data voltages from the (j+1)th source line S(j+1), the (j+2)th source line S(j+2) and the (j+3)th source line S(j+3).

When providing the gate turn-on signal through the (i+1)th gate line G(i+1), namely, in the (i+1)th driving cycle of providing driving signal through the (i+1)th gate line G(i+1), since the pixel PX1, pixel PX3 and pixel PX5 are connected with the (i+1)th gate line G(i+1), the pixels PX1, PX3 and PX5 are respectively received the corresponded data voltages from the (j+1)th source line S(j+1), the (j+2)th source line S(j+2) and the (j+3)th source line S(j+3).

When providing the gate turn-on signal through the (i+2)th gate line G(i+2), namely, in the (i+2)th driving cycle of providing driving signal through the (i+2)th gate line G(i+2), since the pixel PX8, pixel PX10 and pixel PX12 are connected with the (i+2)th gate line G(i+2), the pixels PX8, PX10 and PX12 are respectively received the corresponded data voltages from the (j+1)th source line S(j+1), the (j+2)th source line S(j+2) and the (j+3)th source line S(j+3).

When providing the gate turn-on signal through the (i+3)th gate line G(i+3), namely, in the (i+3)th driving cycle of providing driving signal through the (i+3)th gate line G(i+3), since the pixel PX7, pixel PX9 and pixel PX11 are connected with the (i+3)th gate line G(i+3), the pixels PX7, PX9 and PX11 are respectively received the corresponded data voltages from the (j+1)th source line S(j+1), the (j+2)th source line S(j+2) and the (j+3)th source line S(j+3).

Otherwise, according to the exemplary embodiments of the present disclosure, the display panel 100 is driven in column inversion driving mode, two column inversion driving mode, one dot inversion driving mode. For example, as shown in FIG. 2, the (i+1)th source line respectively provides the data voltages of which the polarities are respectively “−”, “−”, “+” and “+” to the pixel PX2, the pixel PX3, PX8 and PX9 in the ith driving cycle, the (i+1)th driving cycle, the (i+2)th driving cycle and the (i+3)th driving cycle. Namely, between the (i+1)th driving cycle and the (i+2)th driving cycle, the polarity of the date voltage becomes from “−” to “+”.

This change will cause the insufficient charge of the data voltage provided to the pixel PX8 resulted by RC delay, thereby resulting the dim screen.

In order to solve the above issue, for the same source line, (for example a controller 100) based on whether if between the data voltage provided by the current driving cycle and the data voltage provided by the previous driving cycle occurs the polarity change to compensate the data voltage provided by the current driving cycle based on the data voltage provided by the current driving cycle and the data voltage provided by the previous driving cycle.

For example, for the (i+1)th source line S(i+1) as shown in FIG. 2, the polarities of the data voltages provided during the ith driving cycle and the (i+1)th driving cycle are “−”, namely, the polarity of the data voltage between the ith driving cycle and the (i+1)th driving cycle is not changed, therefore, the data voltage provided to the pixel PX3 through the (i+1)th source line S(i+1) in the (i+1)th driving cycle will not be compensated. Similarly, for the (i+1)th source line S(i+1), the polarities of the data voltages provided during the (i+2)th driving cycle and the (i+3)th driving cycle are “+”, the polarity of the data voltage between the (i+2)th driving cycle and the (i+3)th driving cycle is not changed, therefore, the data voltage provided to the pixel PX9 through the (i+1)th source line S(i+1) in the (i+3)th driving cycle will not be compensated.

However, for the (i+1)th source line S(i+1), the polarities of the data voltages provided by the (i+1)th driving cycle and the (i+2)th driving cycle are respectively “−” and “+”, namely, the polarity of the data voltage between the (i+1)th driving cycle and the (i+2)th driving cycle is changed, therefore, the data voltage provided to the pixel PX8 through the (i+1)th source line S(i+1) in the (i+2)th driving cycle will be compensated.

Since the polarity of the data voltage is changed (namely is reversal), the controller 100 can compensate the current data voltage V0 and can determine the final data voltage V1, and providing the final data voltage V1 to the corresponded pixel (for example the pixel PX8).

According to the exemplary embodiments of the present disclosure, the controller 100 may determine whether the polarity of the voltage changes (namely is reversal) according to the polarity control signal POL.

Moreover, according to the exemplary embodiments of the present disclosure, (for example a controller 100) calculates the compensation values of the data voltage of the current driving cycle based on the data voltage provided by the current driving cycle and the data voltage provided by the previous driving cycle.

Moreover, according to the exemplary embodiments of the present disclosure, a lookup table as shown in Table 1 is able to be stored in advance in the storage of the display device, the data voltage of the current driving cycle and the data voltage of the previous retrieve the corresponding compensation value from the look-up table stored in advance.

| | Previous driving cycle | | | | | | | | | |
|---|---|---|---|---|---|---|---|---|---|---|
| | Gray level | | | | | | | | | |
| | value | 0 | 32 | 64 | 96 | 128 | 160 | 192 | 224 | 255 |
| Current | 0 | 0 | 1 | 1 | 1 | 2 | 2 | 2 | 3 | 3 |
| driving | 32 | 33 | 33 | 33 | 34 | 34 | 34 | 35 | 35 | 35 |
| cycle | 64 | 65 | 65 | 65 | 66 | 66 | 66 | 66 | 67 | 67 |
| | 96 | 98 | 98 | 98 | 99 | 99 | 99 | 100 | 100 | 100 |
| | 128 | 131 | 131 | 131 | 131 | 132 | 132 | 132 | 132 | 133 |
| | 160 | 163 | 163 | 163 | 163 | 163 | 164 | 164 | 164 | 164 |
| | 192 | 195 | 195 | 195 | 195 | 196 | 196 | 196 | 196 | 196 |
| | 224 | 227 | 227 | 227 | 227 | 227 | 228 | 228 | 228 | 228 |
| | 255 | 255 | 255 | 255 | 255 | 255 | 255 | 255 | 255 | 255 |

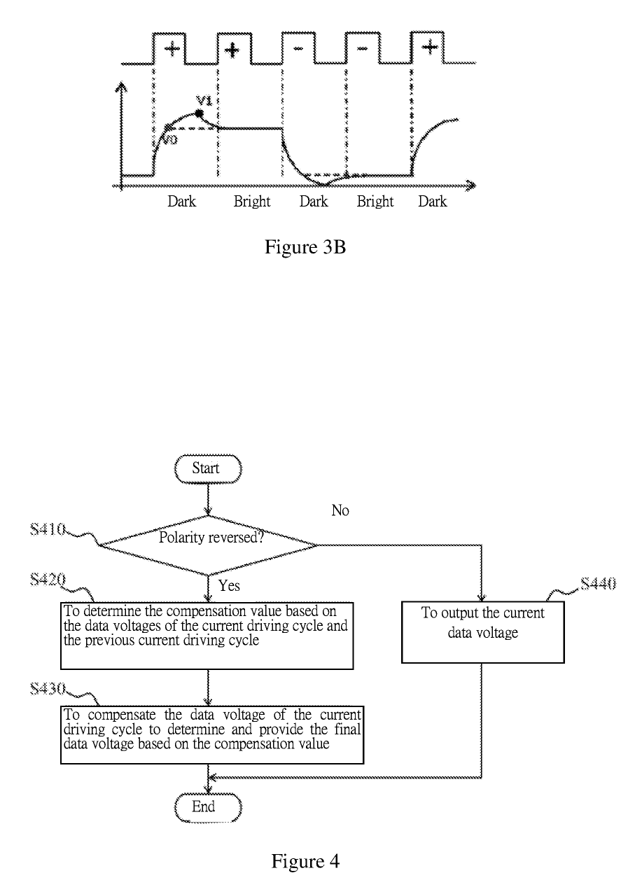

FIG. 3A and FIG. 3B are respectively comparative diagrams of the driving method of the prior art and the driving method of the exemplary embodiment of the present disclosure, wherein FIG. 3A illustrates the data voltage of the driving method according to the prior art, FIG. 3B illustrates the data voltage of the driving method according to the exemplary embodiments of the present disclosure.

Through the comparative data voltage as shown in FIG. 3A and 3B, obviously, through the driving method of the exemplary embodiments of the present disclosure can improve the issue of dim screen.

FIG. 4 is a flow chart of the driving method of the display panel according to the exemplary embodiment of the present disclosure. As described above, the display panel according to the exemplary embodiment of the present disclosure comprises m source lines arranged along the first direction (for example a column direction), n gate lines arranged along the second direction (for example a row direction) perpendicular to the first direction and intersected with said m source lines, and m×n pixels of a two-dimensional array formed on the intersection of m source lines and n gate lines, wherein m and n are positive integers.

According to the exemplary embodiment of the present disclosure, said display panel is driven in column inversion driving mode, two column inversion driving mode, one dot inversion driving mode according to a progressive approach.

In step S410, to determine whether the polarity of the data voltage provided through the source line is changed. For each source line of said plurality of source lines, to determine whether the polarity between the data voltage provided by the current driving cycle and the data voltage provided by the previous driving cycle is changed. For example, for the display panel 100 as shown in FIG. 2, to determine whether the polarity of the data voltage provided through the jth source line in the ith driving cycle of the driving signal provided by the ith gate line corresponded to the (i−1)th driving cycle of the driving signal provided by the (i−1)th gate line is changed, wherein 2≤i≤n, 1≤j≤m.

Herein, the data voltage provided by the source line is corresponded to a gray voltage of the gray level value.

When the polarity of the data voltage provided by the jth source line is changed, when the polarity is changed in step S420, when the polarity of the data voltage provided by the jth source line is changed, to determine the compensation value based on the data voltage provided by the current driving cycle and the data voltage provided by the previous driving cycle. For example, to determine the compensation value based on the data voltage provided through the jth source line in the ith driving cycle and the data voltage provided through the jth source line in the (i−1)th driving cycle.

Herein, to calculate the compensation value based on the data voltage provided through the jth source line in the ith driving cycle and the data voltage provided through the jth source line in the (i−1)th driving cycle. Or of retrieve the compensation value from the look-up table based on the data voltage provided through the jth source line in the ith driving cycle and the data voltage provided through the jth source line in the (i−1)th driving cycle.

In step S430, to determine the final data voltage provide through the source line and to provide the determined final data voltage to the corresponded pixel through the source line. Herein to determine the final data voltage provided through the jth source line in the ith driving cycle based on the data voltage and said compensation value provided through the jth source line in the ith driving cycle.

Otherwise, according to the exemplary embodiment of the present disclosure, only to determine the compensation value when the polarity of the data voltage provided through the source line is changed, namely, to determine the corresponded data voltage to the final data voltage before the polarity of the date voltage provide through the source line changed and to provide the final data voltage to the corresponded pixel through the corresponded source line.

According to the exemplary embodiment of the present disclosure, for the same source line, based on whether if between the data voltage provided by the current driving cycle and the data voltage provided by the previous driving cycle occurs the polarity change to compensate the data voltage provided by the current driving cycle based on the data voltage provided by the current driving cycle and the data voltage provided by the previous driving cycle, thereby providing the compensated data voltage to the corresponded pixel, so that the issue of the dim screen caused by the polarity inversion can be solved, thereby improving the display quality of the display panel.

Furthermore, according to the above described method of the present disclosure can be implemented as a computer code in the computer readable recording medium. Skilled in the art can implement the computer code according to the above method. The above described method of the present disclosure will be implemented when the computer code is executed in the computer.

Moreover, each unit in the color temperature adjustment device of the liquid crystal panel according to the exemplary embodiments of the present disclosure can be implemented to hardware component. The processing performed by those skilled in the art according each limited unit can use FPGA or ASIC to achieve each unit.

The above description is only the specific embodiment in the present invention, be noted that, for those ordinary technical personnel in this art, it also can be improved and modified under the circumstance of without disobeying the present application principle, these improvements and modifications are also considered in the scope of the present application.

What is claimed is:

1. A driving method of a display panel, said display panel comprising a plurality of source lines arranged in first direction, a plurality of gate lines arranged in second direction which is perpendicular to the first direction and crossed said plurality of source lines, and a plurality of pixels which is provided on the intersection of said plurality source lines and said plurality of gate lines to form a two-dimensional array, said display panel being driven in progressive driving mode, comprising the following steps:
for each source line of said plurality of source lines, to determine whether between a data voltage provided by the current driving cycle and a data voltage provided by the previous driving cycle has polarity change;
when the polarity change occurs, when the polarity of the data voltage provided by the jth source lines is changed, to determine a compensation value based on the data voltage provided by the current driving cycle and the data voltage provided by the previous driving cycle;
to compensate the data voltage provided by the current driving cycle based on the determined compensation values, to determine a final data voltage provided by the previous driving cycle.

2. The driving method as claimed in claim 1, wherein the steps of determining the compensation values comprise:
only when the polarity change occurs, to determine the compensation values.

3. The driving method as claimed in claim 1, wherein the steps of determining the compensation values comprise:
to calculate the compensation values based on the data voltage provided by the current driving cycle and the data voltage provided by the previous driving cycle; or
to retrieve the compensation values from the look-up table based on the data voltage provided by the current driving cycle and the data voltage provided by the previous driving cycle.

4. The driving method as claimed in claim 1, wherein the data voltage provided by the source line is corresponded to the gray level value.

5. The driving method as claimed in claim 2, wherein the data voltage provided by the source line is corresponded to the gray level value.

6. The driving method as claimed in claim 3, wherein the data voltage provided by the source line is corresponded to the gray level value.

7. The driving method as claimed in claim 1, wherein said display panel is driven in column inversion driving mode, two column inversion driving mode, one dot inversion driving mode.

8. A display device, comprising:
a display panel, a plurality of source lines arranged in first direction, a plurality of gate lines arranged in second direction which is perpendicular to the first direction and crossed said plurality of source lines, and a plurality of pixels which is provided on the intersection of said plurality source lines and said plurality of gate lines to form a two-dimensional array;
a source driver, which is constituted to provide a data voltage to pixels through said m source lines;
a gate driver, which is constituted to sequentially provide a driving signal to said plurality of gate lines in order to control the pixel to receive the timing of the data voltage;
a controller, which is constituted to control the source driver to provide a data voltage, and the gate driver providing the sequence of the driving signals,
wherein said controller is constituted to:
for each source line of said plurality of source lines, to determine whether between a data voltage provided by the current driving cycle and a data voltage provided by the previous driving cycle has polarity change;
when the polarity change occurs, when the polarity of the data voltage provided by the jth source lines is changed, to determine a compensation value based on the data voltage provided by the current driving cycle and the data voltage provided by the previous driving cycle;
to compensate the data voltage provided by the current driving cycle based on the determined compensation values, to determine a final data voltage provided by the previous driving cycle.

9. The display device as claimed in claim 8, wherein said controller determines the compensation values only when the polarity change occurs.

10. The display device as claimed in claim 8, wherein said controller calculates the compensation values based on the data voltage provided by the current driving cycle and the data voltage provided by the previous driving cycle, or retrieves the compensation values from the look-up table based on the data voltage provided by the current driving cycle and the data voltage provided by the previous driving cycle.

11. The display device as claimed in claim 8, wherein the data voltage provided by the source line is corresponded to a gray voltage of the gray level value.

12. The display device as claimed in claim 9, wherein the data voltage provided by the source line is corresponded to a gray voltage of the gray level value.

13. The display device as claimed in claim 10, wherein the data voltage provided by the source line is corresponded to a gray voltage of the gray level value.

14. The display device as claimed in claim 8, wherein said display panel is driven in column inversion driving mode, two column inversion driving mode, one dot inversion driving mode.
